(19) United States
(12) Patent Application Publication
(10) Pub. No.: US 2016/0079908 A1
(43) Pub. Date: Mar. 17, 2016

(54) Photovoltaic Array Using Integrated Boards

(71) Applicant: Tao SUN, (US)

(72) Inventor: Tao Sun, Suzhou (CN)

(21) Appl. No.: 14/774,246

(22) PCT Filed: Mar. 5, 2014
(86) PCT No.: PCT/CN2014/072880

§ 371 Date: Sep. 10, 2015

(30) Foreign Application Priority Data
Mar. 12, 2013 (CN) 201310077403.1

(51) Int. Cl. H02S 20/00

(52) U.S. Cl. CPC H02S 20/00

(57) ABSTRACT

A photovoltaic array using photovoltaic module integrated boards comprises at least two cross beams and at least two photovoltaic module integrated boards; the angle between the longitudinal axes of the at least two beams is less than 15 degrees; the angle between the longitudinal axis of at least one beams and the longitudinal axis of the at least two photovoltaic module integrated boards is not less than 30 degrees and not more than 150 degrees; and the total area of all the photovoltaic module integrated boards supported by at least one group of the beams is more than 12 square meters. The present invention is designed to share beams, columns and foundations, thus saving materials and installation time and greatly reducing cost.

### BACKGROUND OF THE INVENTION

1. Technical Field

The present invention relates to a solar photovoltaic power generation system. More particularly, this invention relates to a photovoltaic array using photovoltaic modules integrated boards(Abbreviation: integrated boards).

2. Description of Related Art

Solar energy are clean, inexhaustible. Most renewable energy such as wind, hydropower, biomass is transformed from solar indirectly. The current dominant fossil fuels such as coal, oil, natural gas also comes from ancient biomass. So solar energy is the most important and most promising renewable energy.

However, the current solar energy people used is less than 1% of the total energy. The main reason is the high cost of solar energy. It can not compete with cheaper conventional fossil energy.

Now the vast majority of current photovoltaic industry have invested too much time and money to improve solar battery efficiency itself, that's not a good idea. Of course, the higher labor costs in the region, the higher efficiency can reduce system installation costs, there is a certain positive significance. But many new rapid mounting device also can significantly reduce system installation costs.

The photovoltaic power plant structure with fixed angle hasn't changed for decades since the invention of the solar cell.

The cost of solar photovoltaic power plant typically includes the following components cost, photovoltaic module cost, bracket cost, foundation costs, labor cost, the cost of the inverter and so on. The total costs except photovoltaic modules is also known as BOS (balance of system) cost.

From the natural law of development of the energy industry, the scale is a common and effective means of reducing costs. In all other power station including wind power, thermal power, nuclear power, hydropower, the nature law is the same. Therefore, the nature law will be the same in photovoltaic power station. The bigger the scale of the power station, the lower the average cost-sharing on a number with fixed costs. According to reports, the average cost of the installed photovoltaic system of less than 2 kW in USA in 2011 is about $ 7.7 per watt, the average cost of the large-scale commercial photovoltaic system of more than 1,000 kilowatts is $ 4.5 per watt and the average cost of the photovoltaic system of more than 10,000 kilowatts is around $3 per watt.

The cost of photovoltaic modules in small or large photovoltaic system is almost the same. So the BOS cost is much higher than the cost of photovoltaic modules. It's well known that photovoltaic modules are made of more sophisticated and expensive components, such as silicon wafer and so on. The support structure is made of cheap steel and cement. So reducing other installation costs become a highest priority.

Currently there are several ways the reduce the installation time:

Firstly, robots were used to install photovoltaic module. But the photovoltaic module is easy to break and it has a flexible cable. So it's difficult for robot to handle.

Secondly, a temporary assembly line can be set up near the photovoltaic power plants. It will assemble photovoltaic components and supporting structure together in the field. However, most photovoltaic power plant has very poor geological and weather conditions, or lack of electricity and engineer. There are some difficulties in temporary assembly lines.

And finally, it's the photovoltaic modules integrated board. the related technologies are still in concept stage.

### SUMMARY OF THE INVENTION

There are still some technical problems regarding integrated boards to be solved, and now they are only in the concept stage. For example, a single integrated board is supported with a plurality of multiple beams, columns, foundation, which is obviously very wasteful. So how to improve the installation efficiency by improving beams, columns, foundations and other support structures, and meet photovoltaic array design requirements and further reduce the cost of photovoltaic array has become an urgent problem.

For the shortcomings existed in the current techniques, this invention provides a photovoltaic array using integrated boards. In the design, several integrated boards share the beams and other support structure. And several boards are mounted side by side on the beam. Generally use two or more beams to support multiple integrated boards.

Here, integrated board refers to an assembly of several photovoltaic modules and their support structures, which is large and easy for installation and transportation. There is a larger size in order to have economies of scale. Integrated board should contain at least two or more photovoltaic modules, and the area of all photovoltaic modules is no less than three square meters. The integrated board may be difficult to handle by hand, and it needs the aid of tools. Ease installation and transportation in order to save labor, to avoid installing and fixing photovoltaic modules piece by piece. It should make the photovoltaic modules fixed with the support structure as a whole. To facilitate the use of container transport, its shape should be elongated plate. Specifically, the ratio of the length and width of the integrated board should be greater than 1.5.

The beam is not arranged in parallel with the integrated board, but intersect at an angle. Of course it is better that the longitudinal axis of the beam is perpendicular to the longitudinal axis of the integrated board.

Structural integrity refers to the overall coordination of the structure under load and ability to maintain the overall force. Structure under loads, only to maintain its integrity, it can be called structure, otherwise it will deform and collapse. The integrity is more associated with the structure's overall shape and stiffness.

To further enhance the structural integrity, multiple integrated boards are fixed on one or more sets of beams, which is a very good solution.

Photovoltaic modules placed piece by piece is clearly not as stable as the integrated board which is connected into one. The structure integrated as one generally will have lower Wind resistance and better stress distribution. While better stress distribution means that you can use less material to support photovoltaic modules, namely lower cost.

For integrated boards, it is the same reason that the integrated boards that placed separately is clearly inferior to the integrated boards which is fixed with same group beam.

Of course, due to transport constraints, integrated board array must be assembled in the field. Multiple integrated boards can share beams, columns and foundations. Multiple integrated boards are mounted side by side on the beam. Generally use two or more than two beams to support multiple integrated boards. Obviously, each beam needs only two columns for supporting. So that it can achieve the purpose of simplifying the support structure.

If considering the integrated boards of left and right sides share a beam for supporting, the required beams, columns and foundation would be even less.

This column is not necessary, you can also use wall support beams. If you use screw pile, foundations and columns can also be combined.

Photovoltaic power plant is photovoltaic power generation system connected to the power grid and transmitted power to the grid.

The photovoltaic array refers to a power generating unit comprising plurality of photovoltaic elements, photovoltaic modules assembled together mechanically and electrically in a certain way and fixed with support structure. photovoltaic array is usually outputting DC. If a photovoltaic module with micro-inverter installed, it can also output AC. Someone also call photovoltaic array as photovoltaic matrix. A photovoltaic array can contain multiple sets of beams.

Typically, photovoltaic array plus combiner box, DC power distribution cabinets, inverters, transformers, AC power distribution cabinets, cables, and many other components form a complete photovoltaic power plant.

The technical solution of the invention is:

A photovoltaic array using integrated boards characterized in that it comprises at least two beams and at least two integrated boards; the angle between the longitudinal axis of the at least two beams is less than 15 degrees; the angle between the longitudinal axis of at least one beam and the longitudinal axis of at least two integrated boards is not less than 30 degrees and no more than 150 degrees; the total area of all integrated boards supported by at least one group of beam is larger than twelve square meters.

One beam can only support the middle of integrated board, equivalent as cantilever. Integrated board is dangling at two ends. It is difficult to support large board. While two beams can support the two ends of integrated boards, and the stress distribution is greatly improved.

All beams supporting an integrated board is a group of beams. Obviously in order to share the beams, at least two integrated boards should be installed at the same group of beams. Of course, the more the better, installing five or even ten could be better.

Usually, people use 20-foot container or 40-foot container to transport goods. A standard 20-foot container is 5.69 meters long, 2.13 meters wide and 2.18 meters high. A standard 40-foot container is 11.8 meters long, 2.13 meters wide and 2.18 meters high. If you want to transport integrated boards and beams with containers, the size should be smaller than the size above-mentioned. In general, vertically place the integrated board, the board width should be less than 2.18 meters, for integrated boards in tilt position, the board width should be less than 3.05 meters. Of course, a ultra-high containers or special container can transport integrated boards which are more than the size mentioned above.

Preferably beams should be installed in parallel position, so installation holes for each integrated board is fixed. You can pre-drilled or riveted nut. But considering a variety of factors like installation error and ground subsidence, there is always a certain angle error between the beams. Because the installation place for the integrated board is unclear, mounting holes are not sure. If drilling in the field will reduce the efficiency of the installation. Of course, you can play a few holes in advance, loaded more than a few nuts. Suppose the beam is 11 meters long, the angle of two longitudinal axis beam is 15 degrees which means that the end of the beam deviation is about 2.80 meters, which has close to half of the length for the integrated board that the 20 feet of the container can hold. Need to play as many holes in the half of the board length range. It is clearly if the deviation beyond this range will increase the cost of the integrated board and it will bring a lot of difficulties for installation and maintenance.

It is better that the beam is perpendicular to integrated boards, that is to say the angle between the longitudinal axis should be 90 degrees. However, if the integrated board is too long, and the space between the beams is too small, the integrated board can also be installed on the beam in a tilt direction. Suppose the length of integrated plate is 5.69 m, an aspect ratio is 2, and the angle to the longitudinal axis of the beam is 30 degrees. The short side of the integrated board is supported by the beams, you can calculate the beam distance is only 0.38 meters which is almost leaning together. if more closer, it will be the whole beam. In FIG. 1, the integrated board is mounted on the tile beam in a 30 degree angle. Because the aspect ratio is larger, and part of the shorter side is floating in the air, it is barely usable. But also tilted installation will waste space. The short side of integrated board floating in the air may cause damage of photovoltaic module. Therefore, the angle between the beam and the integrated board should not be less than 30 degrees and it will be better to be close to vertical. Angle should be no greater than 150 degrees, because the measured angle direction may be different. Measuring 30 degrees in one direction, the supplementary angle measured in the opposite direction will be 150 degrees. The requirements are the same for both of them.

If the width of integrated board is 2.8 m, the total width of two integrated boards is 5.6 meters. Then total area of all integrated boards on a group of beams is twelve square meters, which means that the space between beams will be less than 2.143 meters. General lane is 2.5 meters wide, and the width of a light truck is about 2.1 meters. Considering the beam itself has a certain width, which is clearly below this area and it will be difficult to drive the vehicle through the two beams. At the same time, close space means the same mounting area needs more beams. The closer beam is more difficult to save material and reduce the cost.

This invention comprehensively considers the above factors, the photovoltaic array technology solutions preferably comprises at least two beams and at least two integrated board; the angle between the longitudinal axis of the at least two beams is less than 15 degrees; the angle between at least one beam's longitudinal axis and at least two integrated boards's longitudinal axis is not less than 30 degrees and no more than 150 degrees; the total area of all integrated boards supported by at least one group of beam is larger than twelve square meters.

Preferably, the photovoltaic array using integrated board, including integrated board, beams, columns and foundations. The columns were put on the foundations. At least two beams were fixed on the columns. several integrated boards are mounted on a group of beams, both ends of the integrated board are fixed on the two beams.

Preferably, at least two beams is parallel to each other.

Preferably, two or more integrated boards and beams are perpendicular to each other. For the integrated board has the long strip shape, so perpendicular to the beams is more favorable. Because the space between beams is larger, the required number of beams for he same area of the photovoltaic array will be reduced.

Preferably, the integrated boards is mounted on top of the beam.

Preferably, the height of a plurality of mutually parallel beams is different.

Preferably, the different groups of integrated boards on parallel beams are parallel to each other.

Preferably, at least the angle of two beams with the ground is less than 60 degrees.

Preferably, the same beam with the left and right side are fixed with a group of integrated board.

Front and rear direction of the beam is the longitudinal axis of the beam, followed by the installation of a number of integrated boards; usually the integrated board is fixed on top of the beam. Therefore, both the left and right side install a set of integrated board, so the integrated boards on both sides can share the same beam for support, this will be helpful for saving material.

Preferably, use screws to fix the integrated board and beams.

Preferably, the beam is the closed hollow tube. Closed hollow tube will save significant material than the solid tube material; closed hollow tube, compare with the opening hollow tube, has greater stiffness, which can withstand greater load.

Preferably, the beam is shaped thin-walled metal plate. Shaped thin-walled metal plate is much lighter than the reinforced concrete which is easier to transport and install. Preferably, the ground between two beams is also used as the road for transporting and installing the integrated board.

And because the beams supporting multiple integrated boards, so the span is larger, and integrated board itself has a certain length. The ground between the beams and under the integrated boards can be used as the road to transport and install integrated boards, which can make transportation and installation more easier.

If the angle of beam and the ground is too large, it will lead to high columns and increase the difficulty of installation.

The advantageous effects of the present invention are:

1. Sharing beams, columns and foundations, saving materials and installation time. Greatly reducing the cost.

A plurality of integrated boards share beams, columns and foundations. Obviously, each beam was supported by just two piles. This will reduce beams, columns and foundation. Originally a single integrated board may use two beams, two columns and two foundations. In FIG. 1, for example, five integrated board can share two beams, four columns and foundations. Compare to the stand alone integrated board solution, the beams were reduced by 80%, columns and foundation were reduced by 60%.

If two groups of integrated boards were mounted side by side on one beam, the beams, columns and foundations required even less. In FIG. 5, for example, six integrated boards shared three beams, six columns and foundations. There is 75% reduction in beams and 50% reduction in the columns and foundations. If a group of ten integrated boards instead of three integrated boards mounted on the beam, the number of beams can be reduced by 92.5%, the number of columns and foundations can be reduced by 85%. This is a significant progress.

2. The support on both end of integrated boards also helps reduce the deformation of plate photovoltaic modules.

3. The space between the beams can be used to transport and install integrated boards, which greatly improved the transportation and installation conditions.

4. Installation and removal time is significantly reduced. This can improve the recycle of the photovoltaic power station, which is more environmentally friendly.

5. Suitable for a temporary proposal. Solar power system can be installed quickly in a temporary venue. In some cases it can replace diesel generators, which increase customer value. Rapid disassembly is also more convenient for rent, which greatly changed the traditional business model.

In short, rapid deployment capability to install photovoltaic array can not only reduce costs, but also greatly expanded its use. Considering the large-scale development of solar energy industry in the future, its economic and social benefits are very high. The global large-scale solar photovoltaic power plants installed in 2011 is more than 20 GW. Even if we save the cost of $ 0.01 per watt in the photovoltaic system, it is possible to save more than $200 million. With the continued rapid development of photovoltaic system, the annual installed capacity could grow tenfold or even several times. Then the cost savings will be even more impressive. Thus reducing installation costs of photovoltaic power generation system has an extremely huge economic and social benefits.

### BRIEF DESCRIPTION OF THE DRAWINGS

FIG. 1 is a three-dimensional view of a first embodiment of the present invention.

FIG. 2 is a front view of a first embodiment of the present invention.

FIG. 3 is a plan view of a first embodiment of the present invention.

FIG. 4 is a side view of a first embodiment of the present invention.

FIG. 5 is a three-dimensional view of a second embodiment of the present invention.

FIG. 6 is a front view of a second embodiment of the present invention.

FIG. 7 is a plan view of a second embodiment of the present invention.

FIG. 8 is a side view of a second embodiment of the present invention.

FIG. 9 is a front view of a photovoltaic modules integrated board.

FIG. 10 is three-dimensional view and front view of the main frame of the photovoltaic modules integrated board.

### PREFERRED EMBODIMENT OF THE INVENTION

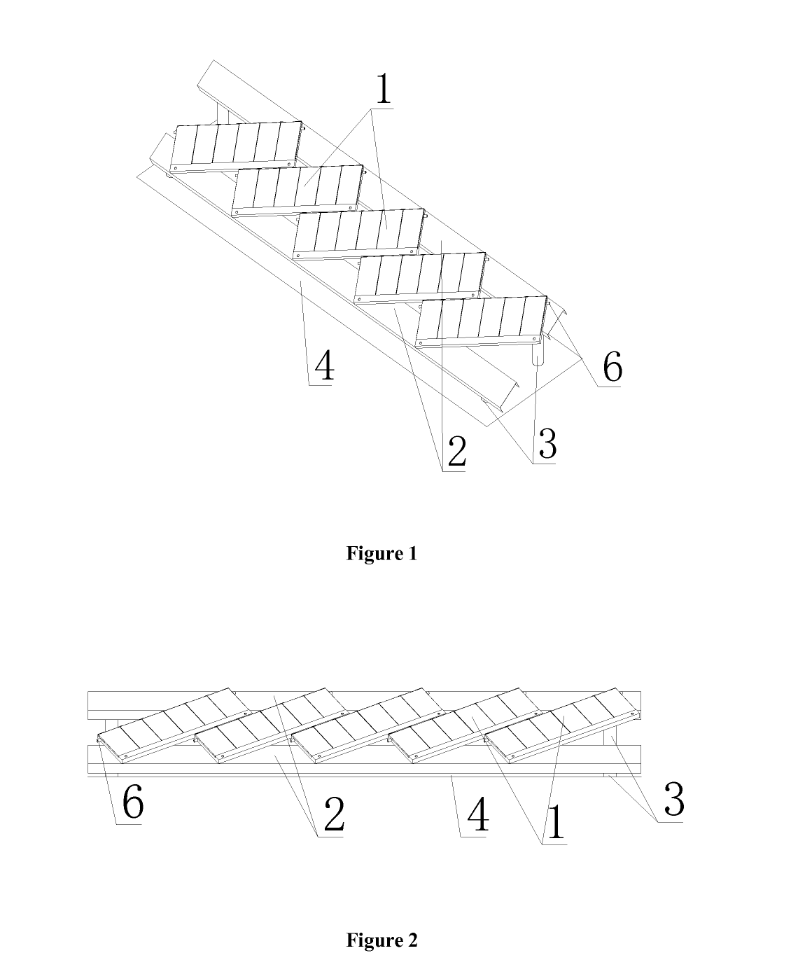

Preferred embodiment of the present invention should make the greatest possible to share beams, columns, foundations and other support structures, which can improve efficiency and further reduce installation materials and time. Obviously the embodiment herein FIG. 5 is better than the first embodiment in FIG. 1. Because more photovoltaic modules integrated boards can share the same set of foundations, columns and beams. The longitudinal axis of integrated board should be perpendicular to the longitudinal axis of the beams. The beams should be parallel. According to the terrain, plant design requirements and transport installation conditions, people should install photovoltaic modules integrated boards as many as possible on the same set of beams, columns, foundations. Due to the design requirements of PV power plant is very complex, there are many factors to consider, such as topographic and geologic, meteorological and hydrological conditions, road traffic conditions, specific structural beam column foundation, exterior shape requirements, etc. Please refer to the preferred embodiment herein, and in accordance with actual conditions to determine how to implement the present invention.

### EMBODIMENT OF THE INVENTION

Implementation, features and advantages of the present invention was further described with reference to the embodiments.

It should be understood that the specific embodiments described herein are merely for explaining the present invention and are not intended to limit the present invention.

A particular embodiment of photovoltaic array using integrated boards comprising at least two fixed beams 2 and at least two integrated boards 1; wherein the angle between the two beams 2 is less than 15 degrees; at least one beam 2 the angle between the longitudinal axis of at least two integrated boards 1 is not less than 30 degrees and not more than 150 degrees; the total area of all integrated boards supported by at least one group of beam is larger than twelve square meters.

The present invention is characterized in that the integrated boards 1 are installed on the beams 2 and fixed with the beams 2.

The present invention is characterized in that at least two beams 2 is mutually parallel.

The present invention is characterized in that the angle between at least two beams 2 and the ground is less than 60 degrees.

The present invention is characterized in that a group integrated boards 1 are fixed at both the left and right side of one beams 2.

The present invention is characterized in that the integrated boards 1 are fixed with the beams 2 by screws.

The present invention is characterized in that the beams 2 is hollow tube.

The present invention is characterized in that beams 2 is shaped thin-walled metal plate.

The present invention is characterized in that at least two integrated boards 1 and beams 2 are perpendicular to each other.

The present invention is characterized in that the height of a plurality of parallel beams is different.

The present invention is characterized in that the ground between beams is regarded as the road to transport integrated boards.

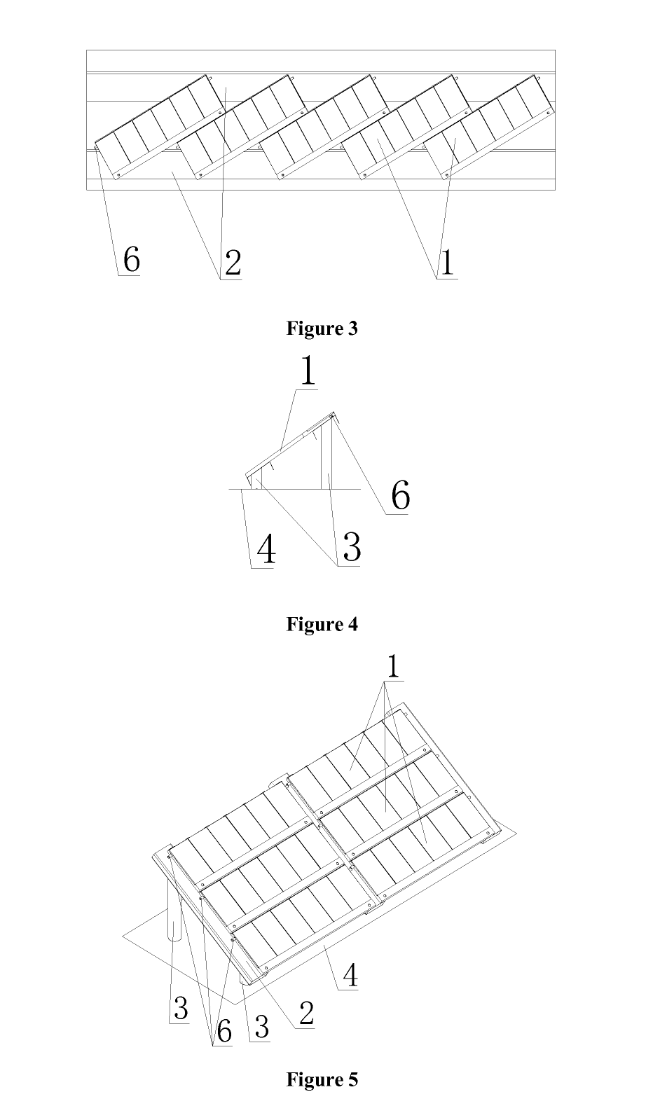

FIG. 1 is a perspective view of a first embodiment of the invention structure. FIG. 2 is a front view of a first embodiment of the invention. FIG. 3 is a plan view of a first embodiment of the invention. FIG. 4 is a side view of a first embodiment of the invention. As shown, photovoltaic array using integrated boards comprises integrated boards 1, beams 2, columns 3 and ground 4. The columns 3 are directly pressed into the ground 4. A plurality of columns support parallel beams 2. Both ends of several integrated boards are fixed on the beams. Two beams are parallel to each other. The height of a plurality of parallel beams is different.

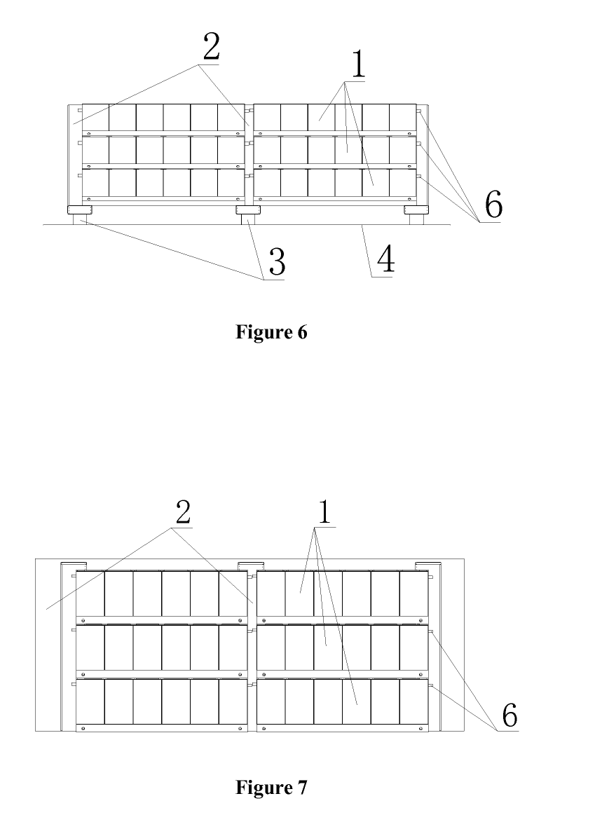

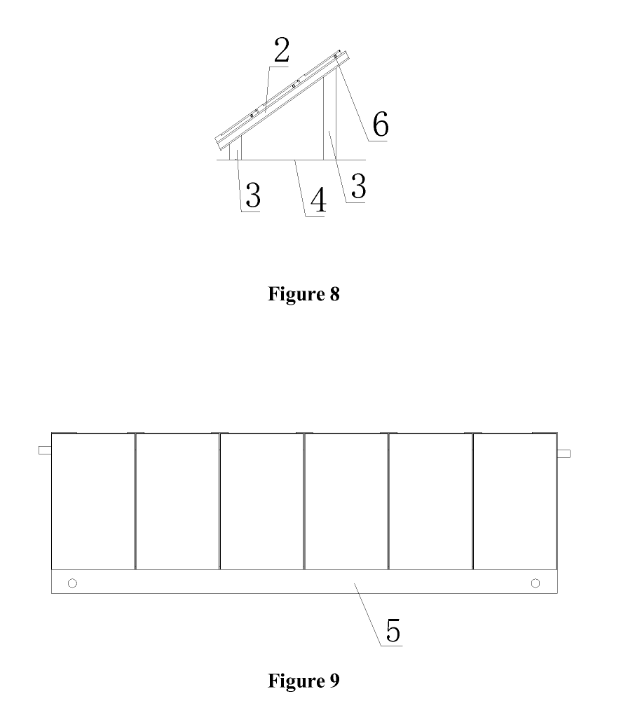

FIG. 5 is a perspective view of a second embodiment of the invention. FIG. 6 is a front view of a second embodiment of the invention. FIG. 7 is a plan view of a second embodiment of the invention. FIG. 8 is a side view of a second embodiment of the invention. As shown in FIG. 5,6,7,8, photovoltaic array using integrated boards includes integrated boards 1, beams 2, columns 3 and ground 4. The columns 3 are directly pressed into the ground 4. A plurality of columns support two parallel beams 2. Two group of integrated boards are placed on the both sides of the beam 2. So they are sharing the same beam. And the integrated boards are perpendicular to the beams.

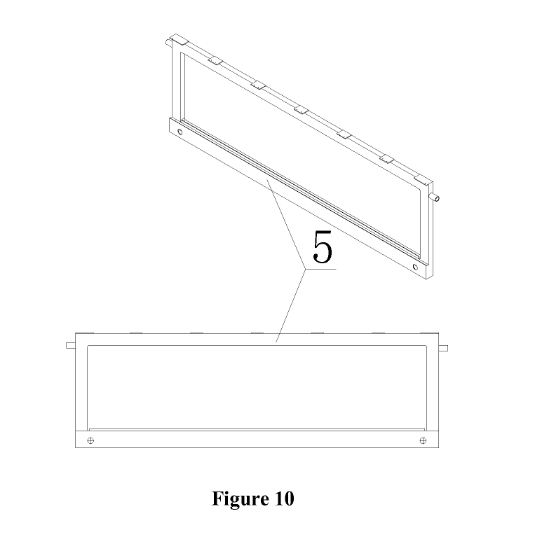

FIG. 9 is a front view of a photovoltaic modules integrated board. FIG. 10 is three-dimensional view and front view of the main frame 5 of the photovoltaic modules integrated board. In FIG. 9, six photovoltaic modules are mounted on the main frame 5. In FIG. 6 and FIG. 10, The lifting rods 6 are fixed on the side of the main frame 5 for lifting and moving the integrated board.

Furthermore, the foregoing descriptions of the embodiments according to the present invention are provided for illustration only, and not for the purpose of limiting the invention as defined by the appended claims and their equivalents.

What is claimed is:

1. A photovoltaic array using integrated boards comprising: at least two beams and at least two integrated boards; the angle between the longitudinal axis of the at least two beams is less than 15 degrees; the angle between the longitudinal axis of at least one beam and the longitudinal axis of at least two integrated boards is not less than 30 degrees and no more than 150 degrees; the total area of all integrated boards supported by at least one group of beam is larger than twelve square meters.

2. The photovoltaic array of claim 1, wherein a group integrated boards are fixed at both the left and right side of one beam.

3. The photovoltaic array of claim 1, wherein the integrated boards are installed on the beam and fixed with the beam.

4. The photovoltaic array of claim 1, wherein at least two beams is mutually parallel.

5. The photovoltaic array of claim 4, wherein multiple beams that the height of parallel beams is different.

6. The photovoltaic array of claim 1, wherein the angle between at least two beams and the ground is less than 60 degrees.

7. The photovoltaic array of claim 1, wherein the integrated boards are fixed with beam by screws.

8. The photovoltaic array of claim 1, wherein the beam is hollow tube.

9. The photovoltaic array of claim 1, wherein the beam is shaped thin-walled metal plate.

10. The photovoltaic array of claim 1, wherein the ground between beams is regarded as the road to transport integrated boards.
